(19) United States
(12) Patent Application Publication
(10) Pub. No.: US 2016/0343026 A1
(43) Pub. Date: Nov. 24, 2016

(54) ADAPTIVE ADVERTISEMENT TARGETING BASED ON PERFORMANCE OBJECTIVES

(71) Applicant: Facebook, Inc., Menlo Park, CA (US)

(72) Inventors: Haibin Cheng, San Jose, CA (US); Sue Ann Hong, San Francisco, CA (US); Rituraj Kirti, Los Altos, CA (US); Benjamin Tucker Savage, San Mateo, CA (US); Gary Wu, Milbrae, CA (US)

(21) Appl. No.: 14/716,772

(22) Filed: May 19, 2015

(51) Int. Cl. G06Q 30/02

(52) U.S. Cl. CPC G06Q 30/0244; G06Q 30/0276; G06Q 30/0251

(57) ABSTRACT

A target audience for an ad campaign is determined during an exploration period of the ad campaign by modifying the target audience based on the fulfillment of performance objectives. An initial target audience may be provided by the advertiser or determined by the social networking system based on ad campaigns having similar ad content or other similar characteristics. Advertisements associated with the ad campaign are served to users of the initial target audience. A subset of the target audience that fulfills the performance objectives of the ad campaign is identified and those users are used to generate a new targeting audience to target users that “look like” the subset of the target audience. The new targeting audience is used in place of the initial target audience to improve targeting for the advertisement. This process may be iteratively performed to refine the target audience during the exploration period.

### BACKGROUND

This invention relates generally to determining target audiences for advertising, and specifically to adapting a target audience based on fulfillment of performance objectives.

Traditionally, advertisers have attempted to tailor advertisements based on expected demographics of users. For example, a business advertising a product may purchase advertising space for that product in a publication read by expected consumers of the publication. Advertisements in the publication thus typically cater to the expected consumer of the publication, but will also be seen by atypical consumers of the publication, who may not be the target audience of the advertiser.

In online systems, such as a social networking system, advertisements are served to users based on target audiences that are associated with the advertisement. Each advertisement has its own target audience of users that are eligible to be presented with the advertisements. Target audiences may also be used with advertising campaigns (“ad campaigns”), which may include multiple advertisements and last for a relatively long period of time. At the start of an ad campaign, an advertiser may not have a good idea of the target audience will be most receptive to their advertisements. Advertisers may invest in formal focus groups and other types of feedback to determine which target audiences best fulfill performance objectives of their ad campaign prior to beginning the ad campaign itself. However, these methods can be expensive and lengthen the time it takes to get an ad campaign to market.

### SUMMARY

A social networking system monitors the performance of advertisements in an advertising campaign (“ad campaign”) and revises a target audience of users of an advertisement based on the advertisement's performance. The advertiser specifies an initial target audience and performance objectives specifying desired user actions with respect to the advertisement. The social networking system evaluates the performance of the ad campaign with respect to the performance objectives during an exploration period of the campaign. The performance of the advertisement in the exploration period determines the final target audience used for the ad campaign. This allows the ad campaign to use an automatically-generated target audience for that specific ad campaign that is based on fulfillment of the associated performance objectives. Thus, an advertiser does not need to identify a target audience for the ad campaign by guessing or investing resources in feedback methods to predict which types of users the ad campaign would perform best with.

During the exploration period, the social networking system serves advertisements from the ad campaign to users that are part of the initial target audience. The social networking system then reviews the performance of the advertisements with respect to the performance objectives, and identifies a subset of the users that fulfill the performance objectives of the ad campaign to generate a new target audience. The new target audience is generated based the users in the subset that fulfilled the performance objectives. That is, the new target audience is selected to target future users that “look like” the specific users that responded positively to the advertisement and met the performance objective. The new target audience is used to subsequently target the advertisements, and the social networking system repeats this process until the exploration period ends and it has identified the final target audience. The final target audience may be used for the duration of the campaign.

The social networking system ends the exploration period once it reaches a designated condition, such as a predetermined time limit, performance goal, or budget limit, all of which may be set by the advertiser. For example, the performance of a set of users may be compared to that of a prior set of users to determine the comparative improvement over iterations of modifying the target audience. Alternatively, the advertiser may specify the end of the exploration period after reviewing iterations of the target audience. In some embodiments, there may be multiple exploration periods within a single ad campaign.

### BRIEF DESCRIPTION OF THE DRAWINGS

FIG. 1 is a high level block diagram of a system environment for a social networking system.

FIG. 2 is an example block diagram of an architecture of the social networking system.

FIG. 3 shows a timeline of an ad campaign, according to one embodiment.

FIG. 4 is a flowchart for modifying a target audience based on performance data, according to one embodiment.

FIG. 5 shows an example of modifying a target audience using seed groups of users during an exploration period for an ad campaign.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

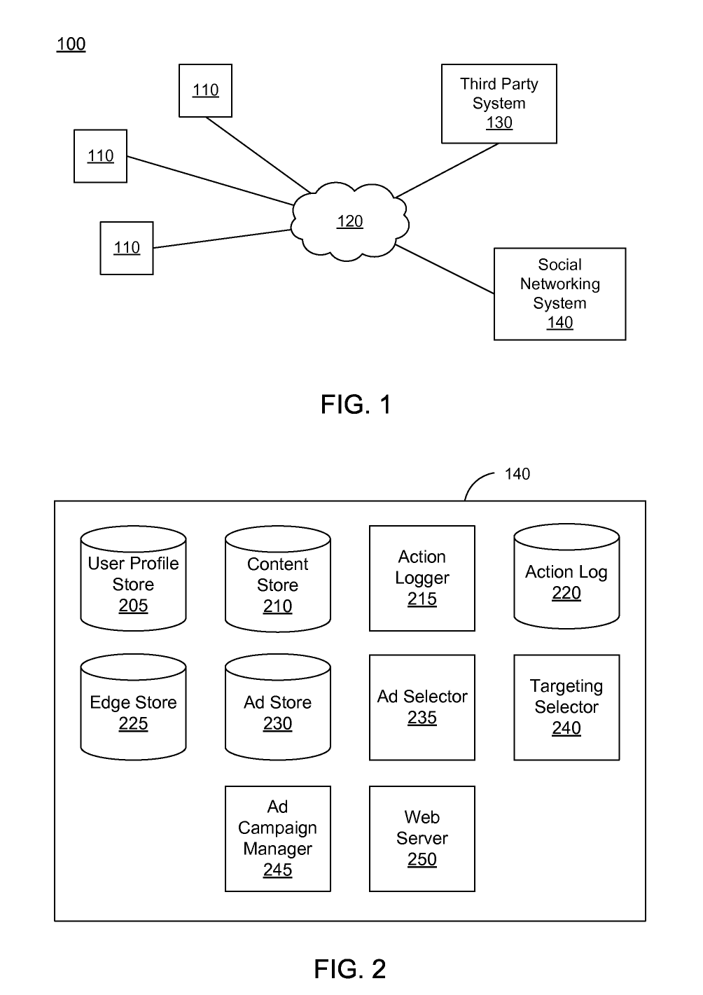

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The social networking system 140 delivers content to users of client devices 110. The social networking system 140 may also deliver advertisements to client devices 110 for users that match advertising criteria of the advertisements. Users may respond to advertisements by performing various actions, such as clicking on the advertisement, visiting a website, purchasing a product, and so forth. The target audience for the advertisements served by the social networking system 140 may be modified to better target users that are more likely to perform actions desired by the advertiser.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130. In some embodiments, the third party system 130 serves advertisements to the users directly, while in other embodiments, the social networking system 140 serves the advertisements.

FIG. 2 is an example block diagram of an architecture of the social networking system 140. The social networking system 140 shown in FIG. 2 includes a user profile store 205, a content store 210, an action logger 215, an action log 220, an edge store 225, an ad store 230, an ad selector 235, a targeting selector 240, an ad campaign manager 245, and a web server 250. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding user of the social networking system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images may be tagged with identification information of users of the social networking system 140 who are displayed in the images. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that represent various types of content. Examples of content represented by an object include a page post, a page like, a page engagement, a status update, a photograph, a video, a link, a shared content item, an application used, a gaming application achievement, a check-in event at a local business, a brand page, an advertisement interaction, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, users of the social networking system 140 are encouraged to communicate with each other by posting text and content items of various types of media through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions are stored in the action log 210. Examples of interactions with objects include: liking a page, interacting with advertisements, using an application, commenting on posts, sharing links, checking-in to physical locations via a mobile device, accessing content items, and any other interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website that primarily sells sporting equipment at bargain prices may recognize a user of a social networking system 140 through a social plug-in enabling the e-commerce website to identify the user of the social networking system 140. Because users of the social networking system 140 are uniquely identifiable, e-commerce websites, such as this sporting equipment retailer, may communicate information about a user's actions outside of the social networking system 140 to the social networking system 140 for association with the user. Hence, the action log 220 may record information about actions users perform on a third party system 130, including webpage viewing histories, interactions with advertisements, purchases made, and other data from shopping and buying.

In one embodiment, an edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system, sharing a link with other users of the social networking system, and commenting on posts made by other users of the social networking system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's affinity for an object, interest, and other users in the social networking system 140 based on the actions performed by the user. A user's affinity may be computed by the social networking system 140 over time to approximate a user's affinity for an object, interest, and other users in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) to present an advertisement to a user are included in the ad store 230. In some embodiments, advertisements are part of an advertising campaign (“ad campaign”), which is a group of advertisements that share one or more characteristics. Advertisements in an ad campaign may share characteristics, such as advertising content (“ad content”), timeframe, budget, targeting criteria and performance objectives. Performance objectives are a measureable goal specified by the advertiser. The performance objectives are actions performed by users that the advertiser is trying to achieve through serving the advertisements in the ad campaign. Examples of performance objectives include clicking on an advertisement, interacting with a page on the social networking system or with an external site, installing an application, expressing an affinity for a page on the social networking system (e.g., “liking” the page), commenting on a page, partaking in a contest or event, responding to a poll in a particular way, and other actions that may be performed on the social networking system 140 or on an external site. For example, if the performance objective is generating “likes” for a particular page, the users that “like” that particular page have performed the performance objective.

An advertisement (“ad”) request includes one or more items of ad content and a bid amount for an ad campaign. The ad content is text, image, audio, video, or any other data presented to a user in the advertisement. In various embodiments, ad content also includes a network address that directs a client device to a landing page when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or if another suitable condition is fulfilled. For example, the bid amount specifies a monetary amount that the social networking system 140 receives from the advertiser if the advertisement is displayed and the expected value is determined by multiplying the bid amount by a probability of the advertisement being accessed.

Additionally, the ad campaign specifies a population of users that is eligible to receive the advertisement, termed a target audience. The target audience may be initially specified by various methods, and subsequently revised by analysis of user responses to the advertisements as further described below. The initial target audience may be specified by the ad request, or may be specified by an advertiser in another way. For example, the initial target audience may be determined by one or more targeting criteria. Targeting criteria specify one or more characteristics of users eligible to be presented with ad content. For example, in one embodiment, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

In one embodiment, targeting criteria may specify actions or types of connections between a user and another user or object of the social networking system 140. Targeting criteria may also specify interactions between a user and objects performed external to the social networking system 140, such as on a third party system 130. For example, targeting criteria identify users that have taken a particular action, such as sending a message to another user, using an application, joining a group, leaving a group, joining an event, generating an event description, purchasing or reviewing a product or service using an online marketplace, requesting information from a third-party system 130, installing an application, or any other suitable action. Including actions in the targeting criteria allows advertisers to further refine users eligible to be presented with content from an ad request. As another example, targeting criteria identify users having a connection to another user or object or having a particular type of connection to another user or object.

The ad content may be presented to users in the target audience in a variety of ways. In one example, the ad content transmitted to a user via a direct message or is otherwise presented to the user without a bidding process. In another example, the ad content is provided responsive to an advertising opportunity from which other advertisements may compete. When an opportunity to present an advertisement is received for a user, the ad selector 235 selects one or more advertisements from the ad store 230 for presentation to the user. The opportunity to present an advertisement may occur when an advertising slot is filled by the social networking system 140, which may be provided with other content provided by the social networking system 140, or the client device 110 may separately request content for an advertising slot. In one embodiment, the ad selector 235 identifies the user as a member of the target audience for an ad campaign and then includes that ad campaign for consideration to provide its ad content to the user. In some embodiments, the ad selector 235 determines a user's likelihood of interacting with the content of various ad requests based on characteristics of the user (“user characteristics”). In one embodiment, the ad selector 235 uses an auction process to rank ad requests according to expected values to the social networking system 100 for presenting content from various ad requests, with an expected value of an ad request based on a bid amount associated with the ad request and a determined likelihood of the user interacting with content in the ad request. Based on the ranking from the auction process, the ad selector 235 selects one or more ad requests and communicates content of selected ad requests to a client device 110 or to a third-party system 130 for presentation to the user. The web server 250 communicates content from the selected one or more ad requests to a client device 110 or a third-party system 130 for presentation.

The targeting selector 240 generates a new target audience for a set of users. The new target audience is generated based on similarities to the users in the set of users. In one embodiment, the set of users have all received the same advertisement. The set of users may have additionally performed the action specified by the performance objective associated with advertisement. For convenience, a user that performs the specified action of the performance objective is termed as meeting the performance objective. Meeting the performance objective may also be termed a conversion, and such users are “converted.” For example, the targeting selector 240 generates a new target audience based on users that met a performance objective for an ad campaign from the prior target audience. The targeting selector 240 may retrieve user characteristics from one or more of the user profile store 305, the action log 320, and the edge store 325. The set of users used to generate the subsequent target audience is termed a seed group.

In one embodiment, the targeting selector 240 generates a new target audience using a training model based on a training cluster of users (in this case, the seed group). The training model is generated based on features associated with the training cluster of users. Features may include any combination of: past engagement history (e.g., pages liked, advertisements clicked, applications installed, websites visited, click-through rates), demographic information, groups, events, and user behavior. Confidence scores based on the number of features of the user matching the features of the training model are then used to identify similar users across populations of users of the social networking system. This method is further described in U.S. patent application Ser. No. 13/297,117, entitled “Generating Clusters of Similar Users for Advertisement Targeting,” filed Nov. 15, 2011, which is hereby incorporated by reference in its entirety.

In another embodiment, the targeting selector 240 generates a new target audience using training models based on cluster groups of users having characteristics similar to the user characteristics of the seed group. To identify members of a cluster group associated with targeting criteria, the social networking system trains a cluster model to determine a measure of similarity between characteristics of a user and the targeting criteria. The trained cluster model is applied to characteristics of a user to generate a cluster score for the user, and the social networking system determines whether the user is a member of the cluster group based on the user's cluster score. In one embodiment, cluster model parameters are weights applied to various characteristics of a user included in the cluster model and used to generate the cluster score based on the cluster model parameters and the characteristics of the user. In one embodiment, a cluster score associated with a user is compared to a cluster cutoff score, and if the cluster score associated with the user equals or exceeds the cluster cutoff score, the user is identified as a member of the cluster group. This allows the social networking system to identify the user as eligible to be presented with advertisements associated with targeting criteria that are associated with the cluster group. This method is further described in U.S. patent application Ser. No. 14/290,355, entitled “Runtime Expansion of Targeting Criteria Based on User Characteristics,” filed May 29, 2014, which is hereby incorporated by reference in its entirety.

The ad campaign manager 245 manages the overall course of an ad campaign and modifies the target audience of the ad campaign. An ad campaign may include one or more exploration periods that are used to optimize the target audience used for the bulk of the ad campaign. An exploration period is a portion of the ad campaign during which the target audience are modified. During the exploration period, the target audience is modified based on how well the users from target audience who are served advertisements meet the performance objectives of the ad campaign.

The ad campaign manager 245 identifies an initial target audience that is used to start the exploration period. In some embodiments, the initial target audience is specified by the advertiser. The advertiser may provide a list of users to use as the initial target audience, indicate that users who have performed a certain action (e.g., like a page associated with the advertiser, interacted with a previous ad from the advertiser) should be used as the initial target audience. In other embodiments, the initial target audience is determined by the ad campaign manager 245 based on similar ad campaigns. Another ad campaign may be deemed similar if the other ad campaign includes similar or identical ad content, or are provided by the same advertiser or by an advertiser providing a similar product. The full target audience of a similar ad campaign or a subset thereof may be used as the initial target audience. The target audience may also be identified based on targeting criteria for the ad campaign. In this case, the characteristics of users are retrieved and compared against the targeting criteria to identify users that match the requirements of the targeting criteria. These users are added to the target audience. The ad campaign manager 245 may retrieve additional user characteristics from the user profile store 205, the content store 210, the action log 220, and the edge store 225 to evaluate user characteristic matching for targeting criteria.

The ad campaign manager 245 receives performance data about one or more advertisements that are served to users in the target audience. The performance data includes indicators of whether a user in the target audience interacted with or converted advertisements that they have been served. In addition to interactions with the advertisement itself, such performance data may include the length of time an advertisement was on-screen, the playtime for a video advertisement, the length of time between clicking an advertisement and any subsequent action at an advertiser's webpage, among others. The performance data is received by the ad campaign manager 245 from the action log 220 or the third party system 130. The ad campaign manager 245 monitors the performance data to determine which users in the target audience meet the performance objective of the ad campaign. The ad campaign manager 245 monitors the performance data for the length of the exploration period.

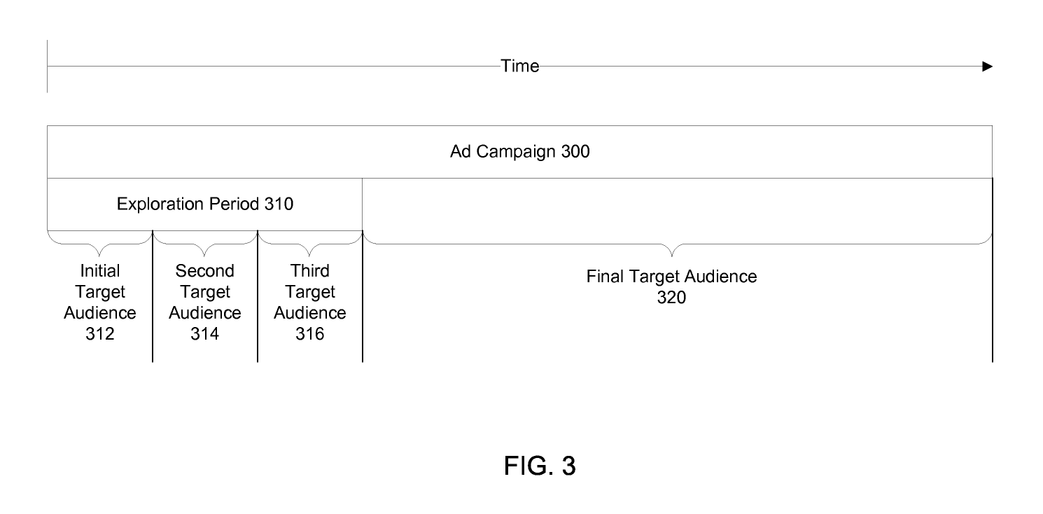

The ad campaign manager 245 creates a seed group of users from the subset of users of the target audience that fulfill the performance objective. The seed group of users is used by the targeting selector 240 to generate a new target audience. The operation of the ad campaign manager 245 and creation of seed groups is further described with respect to FIGS. 3-5.

In some embodiments, the ad campaign manager 245 also stores performance information about the target audience of the previous iteration. The ad campaign manager 245 may compare the performance of the target audience of the current iteration to that of the previous iteration to determine what the incremental improvement in performance is. Additionally, if there is a decline in performance from the target audience of the previous iteration to the target audience of the current iteration, the ad campaign manager 245 can revert to the target audience of the previous iteration.

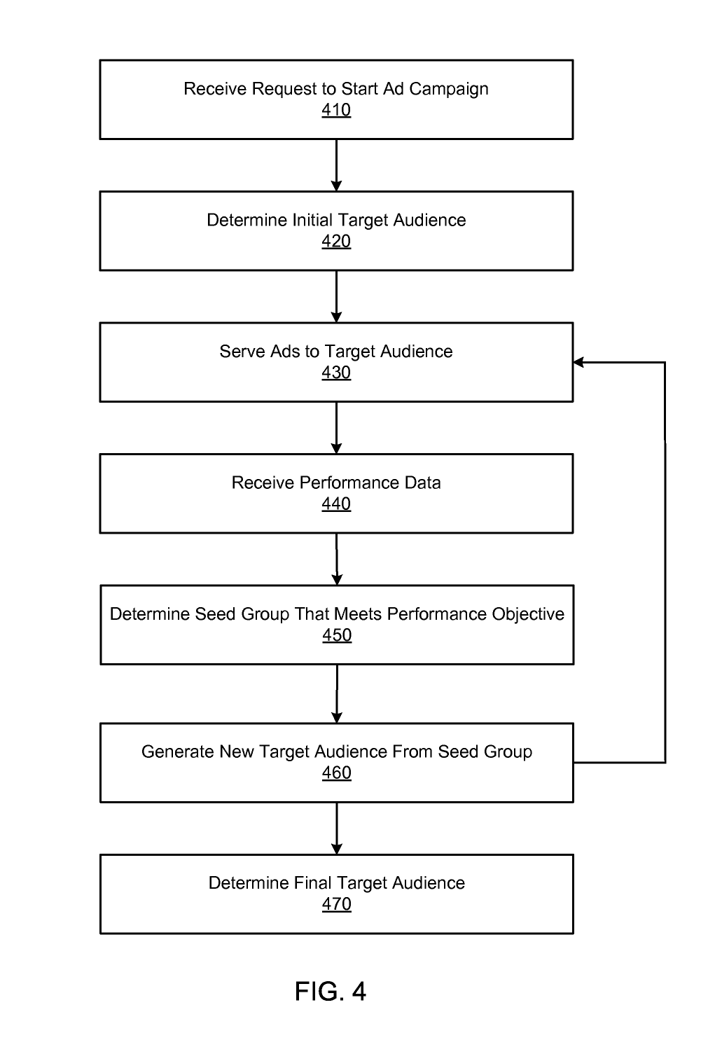

Additionally, the ad campaign manager 245 determines when to end the exploration period and selects final target audience for the ad campaign. This is further described below in conjunction with FIG. 4.

If an ad campaign has several items of ad content that are served to users in different advertisements, the ad campaign manager 245 may revise the target audience for each piece of ad content separately. The ad campaign manager 245 may analyze the target audience data separately for each piece of ad content to determine which users the ad content performs well with. For example, for ad campaign that two items of ad content A and B, the ad campaign manager 245 may find that ad content A performs best with a first subset of the users in the target audience, while ad content B performs best with a second subset of the users in the target audience. The first and second subsets may be used to generate revised target audiences that differ for ad content A and ad content B. Accordingly, the target audience for the ad campaign may be revised for a particular piece of ad content rather than for the ad campaign as a whole.

The web server 250 links the social networking system 140 via the network 120 to the one or more client devices 110, as well as to the one or more third party systems 130. The web server 140 serves web pages, as well as other content, such as content from content store 210 and ad store 230. The web server 250 may receive and route messages between the social networking system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems.

### Target Population Revision During Ad Campaigns

FIG. 3 shows a timeline of an ad campaign 300, according to one embodiment. The ad campaign 300 starts with an exploration period 310, which may be relatively short compared to the overall length of the ad campaign 300 as shown, or may continue through most of an ad campaign. The exploration period 310 is used to determine a final target audience 320 for the ad campaign 300 by modifying the target audience based on the performance objectives of the ad campaign 300. In this example, the exploration period 310 modifies the target audience several times prior to establishing the final target audience 320. During the exploration period 310, advertisements from the ad campaign 300 are served to users in an initial target audience 312.

Based on the performance of the advertisement with the initial target audience 312, a second target audience 314 is generated to target users that are expected to respond to the advertisement better than the initial target audience 312. As described further below, the set of users in the initial target audience 312 that responded positively to the advertisement, as measured by the performance objectives, are identified and used to generate the second target audience 314. The advertisement from the ad campaign 300 is then served to users from the second target audience 314.

Based on the performance of the second target audience 316, a third target audience 316 is generated to target users that the advertisement may perform even better with. The advertisement is served to users from the third target audience 316, and may continue through the exploration period 310. The number of distinct target audiences that are used in the exploration period 310 before can vary with each ad campaign 300 because the exploration period 310 continues until an end condition is met. The ad campaign manager 245 determines when to complete the exploration period 310 and select the final target audience based on a predetermined end condition. The predetermined end condition may include a set number of iterations with distinct target audiences, a performance goal, a length of time, a proportion of the ad campaign, or a budget limit, each of which may be set by the advertiser. A performance goal is a threshold of users fulfilling the performance objective. One end condition is when the performance of a particular target audience does not reach a threshold improvement over a prior target audience's performance goal. In some embodiments, there can be multiple predetermined end conditions and the exploration period 310 ends when any end condition is met.

Once the exploration period 310 ends, the final target audience 320 is determined and used for the rest of the ad campaign 300. In an alternate embodiment, the exploration period 310 continues for the entire duration of the ad campaign 300.

FIG. 4 is a flowchart for modifying a target audience based on performance data, according to one embodiment. The social networking system 140 receives 410 a request to start an ad campaign 300 from an advertiser. The ad campaign 300 includes one or more items of ad content to be presented to users as advertisements, and one or more performance objectives. The ad campaign 300 may also include an initial target audience 312 to use in the exploration period 310. Alternatively, the social networking system 140 may determine 420 the initial target audience 312 as described above.

Advertisements featuring the one or more items of ad content are served 430 to users from the initial target audience. The users interact with the advertisements containing the ad content and may complete actions specified by the performance objective.

The ad campaign manager 245 receives 440 data relating to the ads served to the users from the target audience from the action log 220 or the third party system 130. The performance data relates to the one or more performance objectives of the ad campaign. There may be only a single performance objective pursued at a time, or several performance objectives that optimized together. If several performance objectives are optimized together, the performance objectives may be weighted equally or ranked in an order by which they are optimized.

Based on the received data, the ad campaign manager 245 determines 440 the subset of the target audience that meets the performance objective to form a seed group for another target audience. For example, if the performance objective of an advertisement is to generate comments for an article, the users that post a comment on that particular article meet the performance objective and are selected for the seed group.

The seed group may be formed until a seed group end condition occurs, at which point the seed group is identified and a new target audience is generated. Seed group end conditions can include a predetermined number of users that met the performance objective, a predetermined period of time passing, and having served advertisements to all of the users in the target audience. These seed group end conditions may be set by the advertiser or the social networking system. In one embodiment, the seed group is additionally required to include at least a minimum number of users and fewer than a maximum number of users. These minimum and maximum numbers of users may be selected based on the technique that is used to generate a new target audience from the seed group of users to ensure that the new audience is formed from a seed group with enough users to provide sufficient confidence in the selection of users in the target audience.

The targeting selector 240 then uses the seed group to generate 460 a new target audience for the advertising campaign. The targeting selector 240 can generate new target audience in a variety of ways. Several methods include generating a new target audience of users that are similar to users in the seed group, as described in conjunction with the targeting selection 240 in FIG. 2.

During the exploration period 310, steps 430 to 460 are repeated until the exploration period 310 ends. When the exploration period 310 ends, the ad campaign manager 245 determines 470 a final target audience for the ad campaign. The final target audience is then used for the rest of the ad campaign 300. The final audience may be determined based on the target audiences and seed groups of the exploration period. The final audience may be the last target audience in the exploration period, or may be the target audience that had the best performance metrics from among the target audiences in the exploration period. When the last target audience in the exploration period had the best performance metrics, a seed group may be determined for the last target audience and another target group may be generated for that seed group and used for the final target audience.

The end of the exploration period 310 can be triggered by several different events. In one embodiment, the end of the exploration period 310 is set to occur after a predetermined amount of time has passed or a predetermined portion of the ad campaign budget has been spent. These limits may be set by the advertiser. In another embodiment, the exploration period 310 ends when the users from the target audience that have been served the advertisement meet a particular performance level (i.e., a certain percentage of the users fulfilling the performance objective). Alternatively, data about the target audience may be relayed to the advertiser for each iteration of the target audience and the advertiser may use the performance data to determine when to end the exploration period 310. In some embodiments, there are several exploration periods 310 during the ad campaign 300.

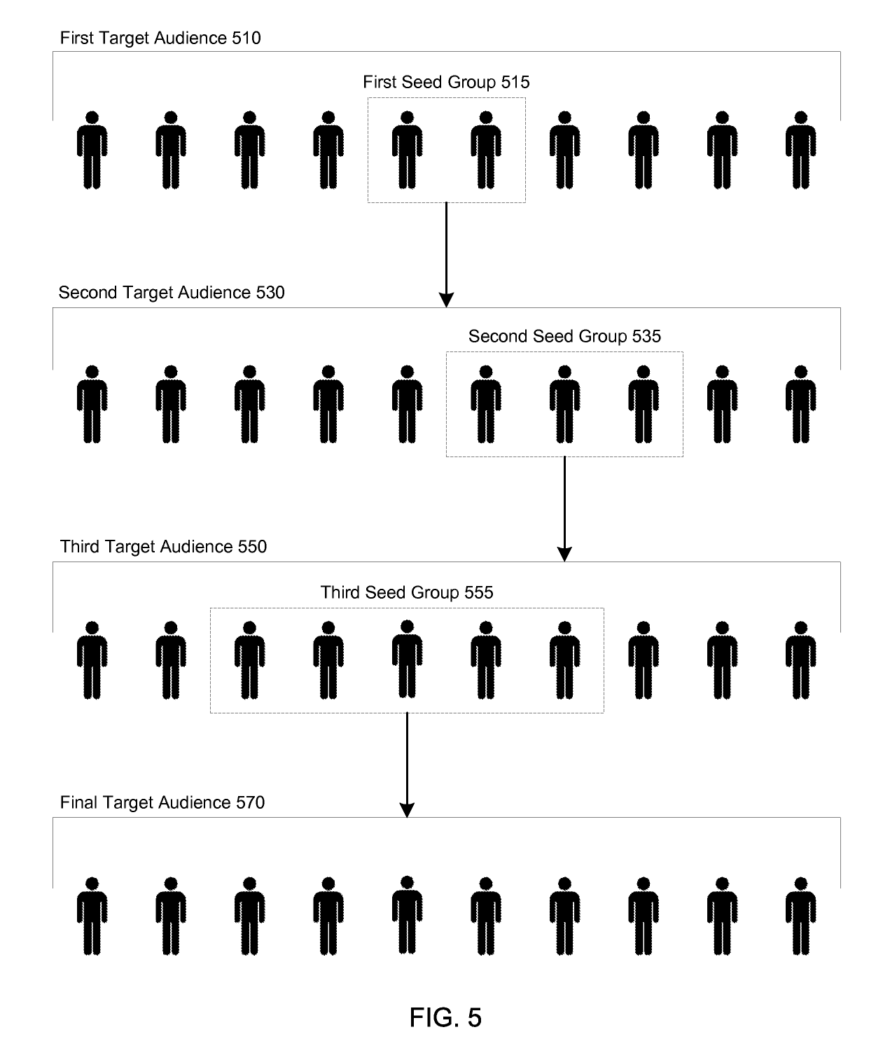

FIG. 5 shows an example of modifying a target audience using seed groups of users during an exploration period for an ad campaign. For ease of illustration, the target audiences in this example each contain ten users. In practice, target audiences may have thousands, tens of thousands, or more users. In this example, each user in the target audience receives the advertisement. In some cases, as described above, the advertisement is presented to a portion of the target audience. Additionally, the number of users performing a particular action and the thresholds of users performing that action described here for illustration and may differ in practice.

In this example, the ad campaign 300 has a performance objective of generating posts on a page of the social networking system 140. Thus, users that have viewed advertisements associated with the ad campaign 300 meet the performance objective if they subsequently post on the specified page. In this example, the exploration period 310 only continues until an end condition is met. The end condition in this example is when 50% of the users from the target audience who were served the advertisement perform the action specified by the performance objective. In other words, the exploration period 310 continues until 50% of users from the target audience who were served the advertisement post on the specified page. During the exploration period, the performance of each target audience is evaluated to see if it meets the predetermined end condition. After the end condition is met, the current target audience is used as the final target audience for the remainder of the ad campaign.

The initial target audience 510 may be specified by the advertiser or the social networking system 140. The first target audience 510 includes users served advertisements from the ad campaign 300. After receiving the advertisement, two users from the initial target audience 510 post on the specified page. These two users fulfill the performance objective of the ad campaign 300 and are selected as a first seed group 515 for generating an updated target audience. However, because only 20% of the first the users from the initial target audience 510 who were served the advertisement has performed the performance objective, the end condition of 50% of users from the target audience who were served the advertisement for the exploration period 310 is not met and the exploration period continues. The first seed group 515 is used to generate a second target audience 530.

Users from the second target audience 530 are served advertisements from the ad campaign 300. After receiving the advertisements, three of the users post on the specified page. These three users fulfill the performance objective of the ad campaign 300 and are selected as a second seed group 535 for generating an updated target audience. However, because only 30% of users from second target audience 530 who were served the advertisement performed the performance objective, the end condition of the exploration period 310 is not met. Accordingly, the exploration period 310 continues, and the second seed group 535 is used to generate a third target audience 550.

Users from the third target audience 550 are served advertisements from the ad campaign 300. After receiving the advertisements from the ad campaign 300, five users from the third target audience 550 who were served the advertisement post on the specified page. These users fulfill the performance objective of the ad campaign 300 and are selected as the third seed group 555. Because 50% of the users from the third target audience 550 who were served the advertisement met the performance objective, the end condition of the exploration period 310 is met. Thus, the third seed group 555 is used to generate the final target audience 570 that is used for the remainder of the ad campaign 300. In another embodiment, the third target audience 550 becomes the final target audience 570. The selection from among these target audiences may be based on the end condition or be specified by an advertiser. Thus, the final target audience 570 may be a newly-generated target audience based on the seed group from the last target audience in the exploration period 310, or the final target audience 570 may be the previously-calculated target audience, such as the third target audience 550. This selection may be based, for example, on the end condition satisfied by the exploration period or by the performance goals met by each of the target audiences in the exploration period. Thus, the target audience that targeted users making up the best-performing target audience may be selected as the final target audience.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a request for an ad campaign from an advertiser, the request for the ad campaign comprising a first advertisement and one or more performance objectives specifying user actions performed subsequent to receipt of the first advertisement;
determining a first initial target audience of users who are eligible to be served the first advertisement;
sending the first advertisement for delivery to a first set of users of the first initial target audience of users;
receiving performance data about the first advertisement presented to the first set of users of the first initial target audience of users, the performance data indicating which users performed user actions defined by the one or more performance objectives of the ad campaign;
identifying a first subset of users of the initial target audience that satisfied the one or more performance objectives of the ad campaign based on the received performance data; and
determining a first revised target audience for the ad campaign based on the identified first subset of users of the first initial target audience group.

2. The method of claim 1, wherein the first initial target audience is included in the request for the ad campaign.

3. The method of claim 1, wherein determining the first initial target audience comprises:
identifying another ad campaign based on at least one of:
an additional advertisement associated with the other ad campaign matching the first advertisement,
an additional advertisement associated with the other ad campaign being similar to the first advertisement,
an advertiser associated with the other ad campaign matching the advertiser of the ad campaign, and
an advertiser associated with the other ad campaign selling a similar product to the advertiser providing the ad campaign; and
selecting at least some users from a target audience of the other ad campaign as the first initial target audience.

4. The method of claim 1, wherein the request for the ad campaign includes a second advertisement, and the one or more performance objectives further define user actions performed subsequent to receipt of the second advertisement, further comprising:
determining a second initial target audience of users who are eligible to be served the second advertisement;
sending the second advertisement for display to a second set of users of the second initial target audience of users;
receiving performance data about the second advertisement presented to the second set of users of the second initial target audience of users;
identifying a second subset of users of the second initial target audience that satisfied the one or more performance objectives of the ad campaign based on the received performance data; and
determining a second revised target audience for the ad campaign based on the identified second subset of users of the second initial target audience group.

5. The method of claim 4, wherein the second initial target audience is the same as the first initial target audience.

6. The method of claim 4, wherein the second set of users is the same as the first set of users, and the identified second subset of users is different from the identified first subset of users.

7. A method comprising:
receiving a request for an ad campaign from an advertiser, the request for the ad campaign comprising an advertisement and one or more performance objectives specifying user actions performed subsequent to receipt of the advertisement;
for one or more exploration periods, iteratively repeating steps comprising:
determining an initial target audience of users who are eligible to be served the advertisement;
receiving performance data about the advertisement presented to the set of users of the initial target audience of users, the performance data indicating which users performed user actions defined by the one or more performance objectives of the ad campaign;
identifying a subset of users of the initial target audience that satisfied the one or more performance objectives of the ad campaign based on the received performance data;
determining a revised target audience for the ad campaign based on the identified subset of users of the initial target audience group;
responsive to an end condition occurring, determining that the revised target audience is final target audience; and
responsive to the end condition not occurring, repeating the steps with the revised target audience as the initial target audience; and
using the final target audience for a duration of the ad campaign.

8. The method of claim 7, wherein the initial target audience is included in the request for the ad campaign.

9. The method of claim 7, wherein determining the initial target audience comprises:
identifying another ad campaign based on at least one of:
an additional advertisement associated with the other ad campaign matching the advertisement,
an additional advertisement associated with the other ad campaign being similar to the advertisement,
an advertiser associated with the other ad campaign matching the advertiser of the ad campaign, and
an advertiser associated with the other ad campaign selling a similar product to the advertiser providing the ad campaign; and
selecting at least some users from a target audience of the other ad campaign as the initial target audience.

10. The method of claim 7, wherein the end condition is a predetermined length of time into the ad campaign.

11. The method of claim 7, wherein the end condition is a predetermined amount of a budget associated with the ad campaign spent.

12. The method of claim 7, wherein the end condition is a threshold of the set of users of the initial target audience meeting the performance objective.

13. The method of claim 7, wherein the end condition is an instruction from the advertiser to end the exploration period.

14. The method of claim 7, wherein there is only one exploration period, and the exploration period situated at the beginning of the ad campaign.

15. A computer program product comprising a non-transient computer-readable storage medium containing computer program code for:
receiving a request for an ad campaign from an advertiser, the request for the ad campaign comprising an advertisement and one or more performance objectives specifying user actions performed subsequent to receipt of the advertisement;
for one or more exploration periods, iteratively repeating steps comprising:
determining an initial target audience of users who are eligible to be served the advertisement;
receiving performance data about the advertisement presented to the set of users of the initial target audience of users, the performance data indicating which users performed user actions defined by the one or more performance objectives of the ad campaign;
identifying a subset of users of the initial target audience that satisfied the one or more performance objectives of the ad campaign based on the received performance data;
determining a revised target audience for the ad campaign based on the identified subset of users of the initial target audience group;
responsive to an end condition occurring, determining that the revised target audience is final target audience; and
responsive to the end condition not occurring, repeating the steps with the revised target audience as the initial target audience; and
using the final target audience for a duration of the ad campaign.

16. The computer program product of claim 15, wherein the initial target audience is included in the request for the ad campaign.

17. The computer program product of claim 15, wherein the computer program code for determining the initial target audience comprises:
identifying another ad campaign based on at least one of:
an additional advertisement associated with the other ad campaign matching the advertisement,
an additional advertisement associated with the other ad campaign being similar to the advertisement,
an advertiser associated with the other ad campaign matching the advertiser of the ad campaign, and
an advertiser associated with the other ad campaign selling a similar product to the advertiser providing the ad campaign; and
selecting at least some users from a target audience of the other ad campaign as the initial target audience.

18. The computer program product of claim 15, wherein the end condition is a predetermined length of time into the ad campaign.

19. The computer program product of claim 15, wherein the end condition is a predetermined amount of a budget associated with the ad campaign spent.

20. The computer program product of claim 15, wherein the end condition is a threshold of the set of users of the initial target amount meeting the performance objective.
